(19) United States
(12) Patent Application Publication
(10) Pub. No.: US 2019/0178273 A1
(43) Pub. Date: Jun. 13, 2019

(54) RAILWAY VEHICLE BODY AND ASSOCIATED METHOD

(71) Applicant: ALSTOM Transport Technologies, SAINT-OUEN (FR)

(72) Inventors: Bernard AWTUCH, Chateau L'Abbaye (FR); Laurent LALOYAUX, AVESNES-LE-SEC (FR)

(21) Appl. No.: 16/215,687

(22) Filed: Dec. 11, 2018

(30) Foreign Application Priority Data
Dec. 13, 2017 (FR) 17 62075

(51) Int. Cl. F16B 5/04; B61D 17/04

(52) U.S. Cl. CPC F16B 5/04; G01L 5/16; B61D 17/045

(57) ABSTRACT

Disclosed is a railway vehicle body, the body including at least one floor module, at least one wall module and at least one roof module, the modules being connected to one another by rivets. The rivets include lower rivets connecting each wall module to the floor module, the lower rivets including at least one group of stiffening rivets including at least three stiffening rivets that are all arranged along a curve formed in a plane perpendicular to a transverse direction of the body, and having a first end with a first tangent and a second end with a second tangent, the first and second tangents forming an angle between them smaller than or equal to 90°.

### CROSS-REFERENCE TO RELATED APPLICATIONS

This application is a U.S. non-provisional application claiming the benefit of French Application No. 17 62075, filed on Dec. 13, 2017, which is incorporated herein by reference in its entirety.

### FIELD

The present invention relates to a railway vehicle body, the body being of the type comprising at least one floor module, at least one wall module and at least one roof module, the modules being connected to one another by rivets.

The invention also relates to a method for manufacturing the body.

The invention more particularly applies to railway vehicle bodies of the tram, subway, interregional train and similar type.

### BACKGROUND

Railway vehicle bodies are known comprising one or several wall modules, one or several floor modules and one or several roof modules.

During the assembly of the body, these modules are connected to one another for example by welding.

However, assembly by welding may cause a deformation of the modules and thus make the assembly process of such bodies difficult.

To avoid a deformation of the body during assembly, it is further known to connect modules by riveting.

However, a very large number of rivets, for example two thousand, is necessary to provide a rigid and reliable connection between the modules. This results in a high weight of the body of the railway vehicle and makes the assembly of the body complicated and expensive.

### SUMMARY

One aim of the invention is to reduce the number of rivets, while guaranteeing a rigid and safe connection between the modules.

To that end, the invention relates to a railway vehicle body of the aforementioned type, wherein the rivets comprise lower rivets connecting the or each wall module to the or each floor module, the lower rivets comprising at least one group of stiffening rivets, the or each group of stiffening rivets including at least three stiffening rivets that are all arranged along a curve formed in a plane perpendicular to a transverse direction of the railway vehicle body, the curve being continuously differentiable, provided with no inflection point, and having a first end with a first tangent and a second end with a second tangent, said first and second tangents forming an angle between them smaller than or equal to 90°.

According to specific embodiments of the invention, the railway vehicle body also has one or more of the following features, considered alone or according to any technically possible combination(s):
the curve is in an arc of circle shape;
the or each group of stiffening rivets includes at least four stiffening rivets;
for the or each group of stiffening rivets, the stiffening rivets of said group are arranged based on a distribution of the mechanical torsion stresses in each wall module;
the stiffening rivets are arranged in regions of the railway vehicle body concentrating torques around axes transverse to a longitudinal direction of the railway vehicle body;
the or each wall module comprises at least one upright, at least one group of stiffening rivets being arranged at a lower end of the or each upright;
for the or each group of stiffening rivets, the diameter of each stiffening rivet of said group is equal to the diameter of each other stiffening rivet of said group;
the rivets comprise upper rivets connecting the or each wall module to the or each roof module, said upper rivets comprising groups of linear rivets, each group comprising at least three upper rivets aligned with one another;
at least one of the modules from among the floor, wall and roof modules is made up of a pre-equipped module; and
the modules are electrically connected to one another by connectors.

The invention also relates to a method for manufacturing a railway vehicle body, the railway vehicle body comprising at least one floor module, at least one wall module and at least one roof module, the method comprising the following steps:
designing a model for the railway vehicle body, applying static and/or dynamic loads on this model of the railway vehicle body in order to calculate the resultant stresses; and
producing the railway vehicle body, the railway vehicle body being assembled by fixing floor, wall and roof modules to one another by rivets, the rivets comprising lower rivets connecting the or each wall module to the or each floor module, the lower rivets comprising at least one group of stiffening rivets including at least three stiffening rivets arranged based on the distribution in the railway vehicle body of the stresses calculated during the design step.

According to one particular embodiment of the invention, the method for manufacturing the railway vehicle body also has the following feature:
the model designed during the design step is a computer model, the method comprising, between the design and production steps, an intermediate step for validating the railway vehicle body through tests, during which a physical model of the railway vehicle body is at least partially assembled and stresses resulting from static and/or dynamic loads applied in said physical model are measured, at an interface between the or each wall module and the or each floor module, in order to validate the distribution of rivets and in [which], during the production step, the stiffening rivets are arranged based on results of the validation step.

### BRIEF DESCRIPTION OF THE DRAWINGS

The features and advantages of the invention will appear upon reading the following detailed description, provided solely as an example and done in reference to the appended drawings, in which:

FIG. 1 is an exploded perspective view of a railway vehicle body according to the invention;

FIG. 2 is a side view of the railway vehicle body of FIG. 1, shown deformed to illustrate the stresses to which the railway vehicle body is subjected during the application on the latter of static and dynamic loads; and

FIG. 3 is a side view of a detail of a junction of a wall module to a floor module belonging to the railway vehicle body of FIG. 1.

### DETAILED DESCRIPTION

In the description, the terms “over”, “under”, “above”, “below”, “upper” and “lower” are defined relative to an elevation direction of a railway vehicle when it is arranged on rails, i.e., a substantially vertical direction when the train is traveling on horizontal rails. The longitudinal direction is defined by the direction of travel of the railway vehicle and the transverse direction is the direction substantially perpendicular to the longitudinal direction and the elevation direction of the railway vehicle.

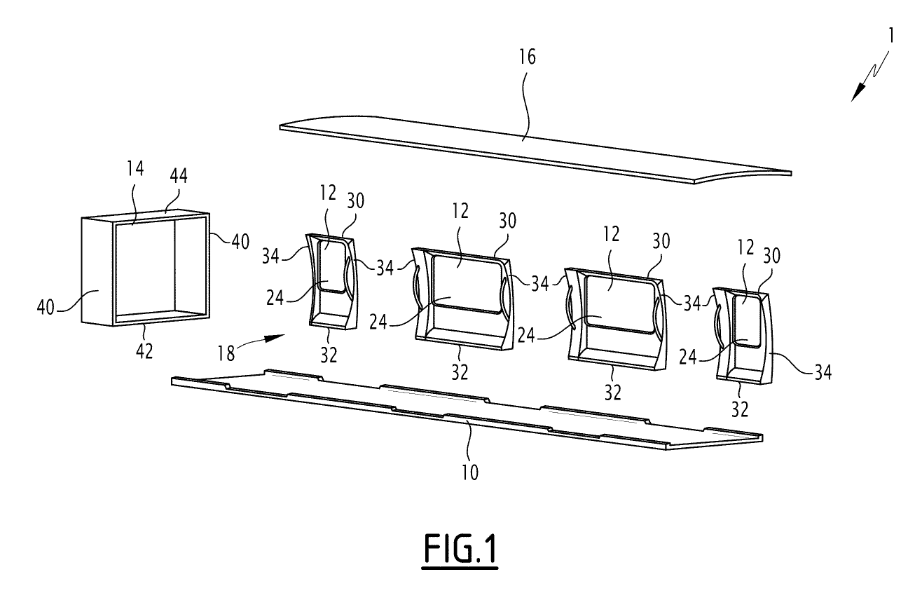

The railway vehicle body 1 shown in FIG. 1 comprises a floor module 10, wall modules 12, end modules 14 and a roof module 16. It will be noted that in FIG. 1, only the wall modules 12 on a first side of the floor 10 and roof 16 modules, and a single end module 14 arranged at a first longitudinal end of the floor 10 and roof 16 modules, are shown; nevertheless, the body 1 also comprises other wall modules 12, not shown, arranged symmetrically to the wall modules 12 visible on the side opposite the modules 10 and 16, and another end module 14, also not shown, arranged at a second longitudinal end of the floor 10 and roof 16 modules opposite the first end.

Alternatively, the body 1 comprises, on each side of the floor 10 and roof 16 modules, a single wall module 12.

The floor 10, wall 12, end 14 and roof 16 modules delimit an interior space 18 inside the body 1 intended to receive occupants of the railway vehicle and/or equipment.

In one example, the modules 10, 12, 14, 16 comprise electronic devices, not shown. The floor 10, wall 12, end 14 and roof 16 modules are for example electrically connected to one another by connectors, not shown.

Preferably, the floor 10, wall 12, end 14 and roof 16 modules are pre-equipped modules.

Alternatively, only one module from among the modules 10, 12, 14 and 16 is a pre-equipped module.

“Pre-equipped module” refers to a module comprising components assembled before the assembly of the module to the other modules of the body 1.

A pre-equipped module is for example configured to be inspected individually with an inspection station provided to that end, at which the installation and/or the correct operation of components and/or electronic devices of said pre-equipped module is for example inspected.

The floor module 10 extends in a horizontal plane. The floor module 10 is arranged below the roof module 16 and is substantially perpendicular to the wall 12 and end 14 modules.

The floor module 10 for example comprises a metal structure configured to bear the weight of the occupants or equipment, not shown, of the railway vehicle. The floor module 10 further comprises a floor for example made from wood or composite or multiple materials attached on an upper face of the structure. The floor typically makes up a floor intended to receive occupants of the railway vehicle and/or equipment of the railway vehicle.

The floor module 10 is connected to the wall modules 12 and the end module 14. Each wall module 12 extends in a vertical plane, perpendicular to the transverse direction. A first part of the wall modules 12 together form a first side wall of the body 1 and a second part of the wall modules 12 together form a second side wall of the body 1, said first and second side walls delimiting the interior space 18 transversely.

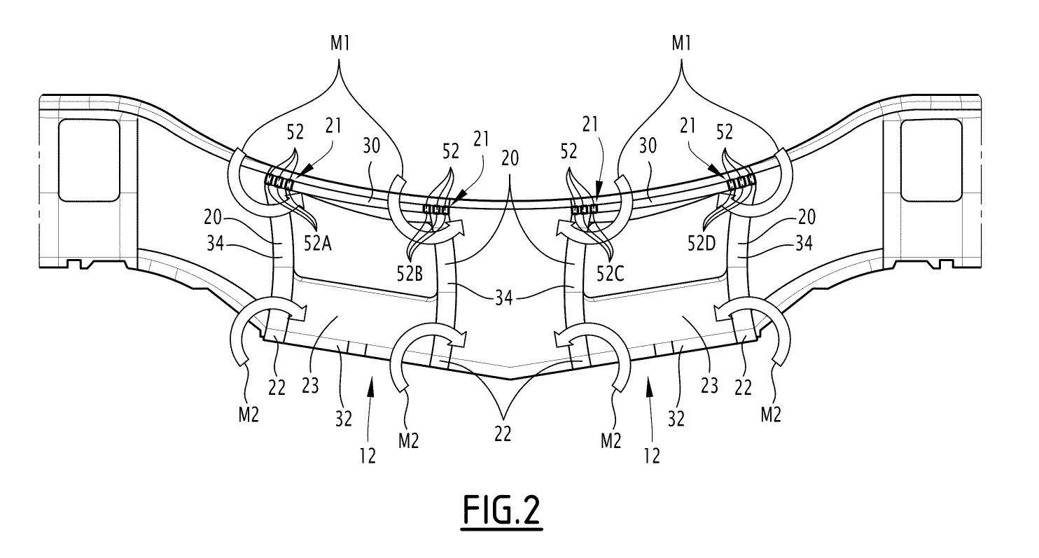

As shown in particular in FIG. 2, each wall module 12 comprises a support structure comprising uprights 20 each connecting the floor module 10 to the roof module 16. These uprights 20 include and, in the illustrated example, are made up of door uprights each delimiting a border of a door arranged in one of the side walls of the body 1.

The uprights 20 each comprise an upper end 21 and a lower end 22.

The upper end 21 is connected to the roof module 16. It forms a potential node of the body 1. In the example of FIG. 2, torsional stresses are present in the upper end 21, said stresses corresponding to a torque M1 exerted around a transverse axis and in a first direction.

The lower end 22 is connected to the floor module 10. It forms a potential node of the body 1. In the example of FIG. 2, torsional stresses are present in the lower end 22, said stresses corresponding to a torque M2 exerted around a transverse axis and in a second direction opposite the first direction.

These stresses are typically produced by the weight of the body 1, passengers, equipment and forces exerted at the longitudinal ends of the body by adjacent bodies (not shown).

The torque M1 typically has a lower intensity than the torque M2.

Each wall module 12 further comprises at least one metal sheet 23 fixed between two uprights 20, and at least one window 24 mounted between two uprights 20, above a metal sheet 23.

Each wall module 12 has an upper edge 30, a lower edge 32 and longitudinal edges 34.

The upper edge 30 is connected to the roof module 16. The lower edge 32 is connected to the floor module 10. The connections between the modules 10, 12, 16 are described in more detail below.

The longitudinal edges 34 are formed by the uprights 20.

Each end module 14 comprises vertical beams 40 and horizontal beams 42, 44, namely a lower beam 42 and an upper beam 44.

The vertical beams 40 are connected to the wall modules 12, the horizontal beam 42 is connected to the floor module 10 and the horizontal beam 44 is connected to the roof module 16.

The roof module 16 for example comprises a vaulted structure and a sheet fixed on the vaulted structure, not shown.

The roof module 16 is connected to the upper edge 30 of each wall module 12 and the upper beam 44 of each end module 14.

The connection between the modules 10, 12, 14, 16 is done by rivets. The rivets comprise lower rivets 50 and upper rivets 52.

The lower rivets 50 connect each wall module 12 to the floor module 10. In particular, the lower rivets 50 comprise groups of stiffening rivets 54 arranged in regions of the body 1 concentrating the torques M2.

These groups of stiffening rivets 54 are for example arranged at the lower end 22 of each upright 20.

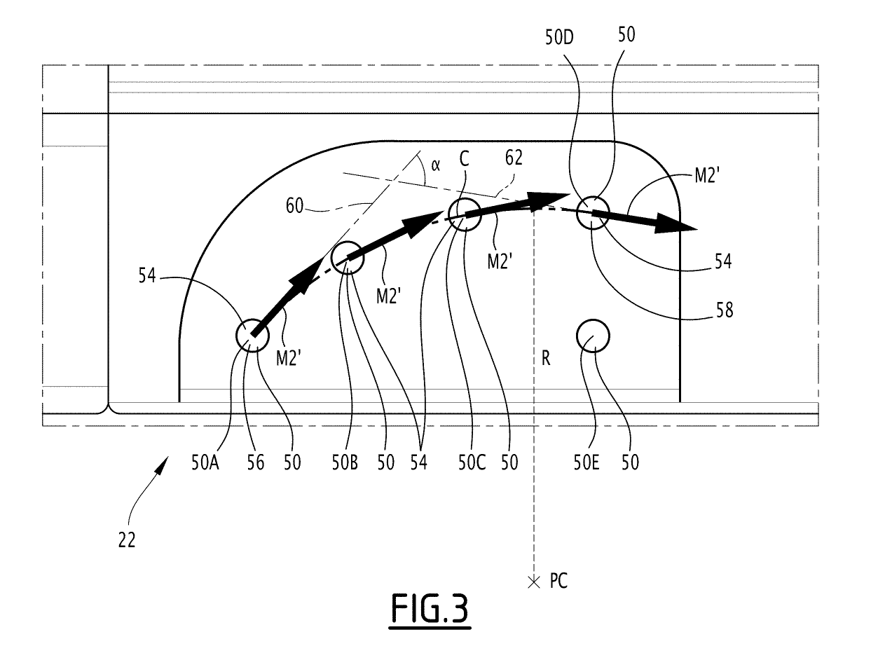

In reference to FIG. 3, each group of stiffening rivets 54 comprises at least three stiffening rivets 50A, 50B, 50C and 50D. In the illustrated example, there are four of these stiffening rivets 50A, 50B, 50C and 50D.

The stiffening rivets 50A, 50B, 50C and 50D each extend along the transverse direction of the body 1. The heads of the stiffening rivets 50A, 50B, 50C and 50D are arranged in a vertical plane, perpendicular to the transverse direction of the body 1.

Preferably, within each group 54, the diameters of the stiffening rivets 50A, 50B, 50C and 50D are equal to one another.

The stiffening rivets 50A, 50B, 50C and 50D are arranged based on a distribution of mechanical stresses in the lower end 22.

To that end, within each group 54, the stiffening rivets 50A, 50B, 50C and 50D of said group 54 are arranged along a curve C formed in a plane perpendicular to a transverse direction of the body 1. In other words, said stiffening rivets 50A, 50B, 50C and 50D are arranged such that it is possible to pass, through said stiffening rivets 50A, 50B, 50C and 50D, a common curve C contained in a plane perpendicular to a transverse direction of the body 1.

A “curve” should be understood as a line with no straight portions. This curve C has no inflection point and is continuously differentiable.

“Continuously differentiable” means that, when the curve C is considered in the plane as a mathematical function, this function is at least of class C¹, i.e., it is differentiable at all points, the derivative in turn being continuous.

The curve C extends from a first end 56 to an opposite second end 58, said ends 56, 58 being defined respectively by a first stiffening rivet 50A and a second stiffening rivet 50D, said first and second stiffening rivets 50A, 50D longitudinally framing the other stiffening rivets 50B, 50C of the group 54. The curve C has, at its first end 56, a first tangent 60, and at its second end 58, a second tangent 62, the angle α between said first and second tangents 60, 62 being less than or equal to 90°, in particular less than or equal to 70°, said angle α being measured in the clockwise direction from the first tangent 60 to the second tangent 62.

The curve C is chosen such that, for each stiffening rivet 50A, 50B, 50C, 50D, shearing forces M2′ exerted on the rivet 50A, 50B, 50C, 50D are oriented along a direction substantially tangent to the curve C. “Substantially tangent direction” means that the angle between said direction and the tangent to the curve C must be less than 10 degrees, preferably 5 degrees.

The distribution of the stresses is for example determined by measurement on a model of the body 1. This model is preferably a digital model, the distribution of the stresses being determined by a digital simulation of said stresses for example by simulation using the finite elements method.

One skilled in the art will understand that other stresses, not shown, lower than the mechanical stresses due to the torque M2, may be present in the lower end 22. In the example of FIG. 3, the torsional stresses make up the main stresses in the lower end 22.

The mechanical torsional stresses are in particular present along the curve C. In the illustrated example, the curve C is in an arc of circle shape in the plane perpendicular to the transverse direction.

This arc of circle has a central point PC and a radius R. The radius R is for example between 100 mm and 200 mm, and preferably between 135 mm and 175 mm.

The upper rivets 52 connect each wall module 12 to the roof module 16.

As shown in FIG. 2, the upper rivets 52 comprise groups of linear rivets 52A, 52B, 52C. Each group of linear rivets 52A, 52B, 52C comprises at least three upper rivets 52 aligned with one another within the group of linear rivets 52A, 52B, 52C.

In other words, the upper rivets 52 are arranged along a line. This line for example extends along the longitudinal direction.

A method for manufacturing the body will now be described.

During a first step for designing the body 1, a computer model of the body 1 is built, such as a model generated by CAD (Computer-Assisted Design), then static and dynamic loads are applied to said model, and the resultant stresses in the body 1 are calculated by a finite-element structure calculation.

In particular, the stresses resulting from the static and/or dynamic loads applied in the model of the body 1, at an interface between the wall 12 and floor 10 modules, are measured.

After the design step, during the step for validating the body 1 through tests, the stresses are measured on a physical model of the body 1, through equipment intended to measure stresses in said physical model. More specifically, the stresses resulting from static and/or dynamic loads applied in the physical model of the body 1 are measured, at the interface between the wall 12 and floor 10 modules in order to validate the distribution of the rivets 50, 54.

Next, during a step for producing the body 1, the body 1 is produced and assembled. The production step for example comprises pre-equipping each module 10, 12, 14, 16 and assembling the modules 10, 12, 14, 16 together.

During the pre-equipping of each module 10, 12, 14, 16, the components of each module 10, 12, 14, 16 are assembled. In other words, each module 10, 12, 14, 16 is equipped before assembling the body 1.

Each pre-equipped module is next preferably inspected at an inspection station. For example, the installation or correct operation of components of the pre-equipped module is inspected.

This pre-equipping is optional.

Then, during the assembly, the floor 10, wall 12 and roof 16 modules are attached to one another by rivets. Optionally, the end module 14 is attached to the other modules 10, 12, 16 by rivets.

In particular, the stiffening rivets 50A, 50B, 50C and 50D are distributed within each group 54 along a curve formed in the plane perpendicular to the transverse direction of the body 1.

The stiffening rivets 50A, 50B, 50C and 50D are arranged depending on the stresses measured in the body 1. In particular, the rivets 50A, 50B, 50C and 50D are arranged in regions where mechanical torsional stresses are concentrated.

One can see that the railway vehicle body 1 makes it possible to reduce the number of rivets needed, while keeping sufficient stability. For example, while keeping the same stability of connections between the modules 10, 12, 14, 16, the number of rivets needed is reduced from two thousand to two hundred.

Arranging the rivets 50A, 50B, 50C and 50D based on the mechanical stresses makes it possible to distribute the mechanical load evenly between said rivets 50A, 50B, 50C and 50D. In other words, each rivet 50A, 50B, 50C and 50D bears a uniform force.

Thus, the diameter of the rivets 50A, 50B, 50C and 50D can be optimized based on a uniform load, and not based on a maximum load.

1. A railway vehicle body, the railway vehicle body comprising at least one floor module, at least one wall module and at least one roof module, the modules being connected to one another by rivets,
wherein the rivets comprise lower rivets connecting the or each wall module to the or each floor module, the lower rivets comprising at least one group of stiffening rivets, the or each group of stiffening rivets including at least three stiffening rivets that are all arranged along a curve formed in a plane perpendicular to a transverse direction of the railway vehicle body, the curve being continuously differentiable, provided with no inflection point, and having a first end with a first tangent and a second end with a second tangent, said first and second tangents forming an angle between them smaller than or equal to 90°.

2. The railway vehicle body according to claim 1, wherein the curve is in an arc of circle shape.

3. The railway vehicle body according to claim 1, wherein the or each group of stiffening rivets includes at least four stiffening rivets.

4. The railway vehicle body according to claim 1, wherein, for the or each group of stiffening rivets, the stiffening rivets of said group are arranged based on a distribution of the mechanical torsion stresses in each wall module.

5. The railway vehicle body according to claim 1, wherein the stiffening rivets are arranged in regions of the body railway vehicle concentrating torques around axes transverse to a longitudinal direction of the body railway vehicle.

6. The railway vehicle body according to claim 1, wherein the or each wall module comprises at least one upright, at least one group of stiffening rivets being arranged at a lower end of the or each upright.

7. The railway vehicle body according to claim 1, wherein, for the or each group of stiffening rivets, the diameter of each stiffening rivet of said group is equal to the diameter of each other stiffening rivet of said group.

8. The railway vehicle body according to claim 1, wherein the rivets comprise upper rivets connecting the or each wall module to the or each roof module, said upper rivets comprising groups of linear rivets, each group comprising at least three upper rivets aligned with one another.

9. The railway vehicle body according to claim 1, wherein at least one of the modules from among the floor, wall and roof modules is made up of a pre-equipped module.

10. The railway vehicle body according to claim 1, wherein the modules are electrically connected to one another by connectors.

11. A method for manufacturing a railway vehicle body, the body railway vehicle comprising at least one floor module, at least one wall module and at least one roof module, the method comprising the following steps:
designing a model for the railway vehicle body, applying static and/or dynamic loads on this model of the railway vehicle body in order to calculate the resultant stresses; and
producing the railway vehicle body, the railway vehicle body being assembled by fixing floor, wall and roof modules to one another by rivets, the rivets comprising lower rivets connecting the or each wall module to the or each floor module, the lower rivets comprising at least one group of stiffening rivets including at least three stiffening rivets arranged based on the distribution in the railway vehicle body of the stresses calculated during the design step.

12. The manufacturing method according to claim 11, wherein the model designed during the design step is a computer model, the method comprising, between the design and production steps, an intermediate step for validating the railway vehicle body through tests, during which a physical model of the railway vehicle body is at least partially assembled and stresses resulting from static and/or dynamic loads applied in said physical model are measured, at an interface between the or each wall module and the or each floor module, in order to validate the distribution of rivets and wherein, during the production step, the stiffening rivets are arranged based on results of the validation step.
